(19) United States
(12) Patent Application Publication
(10) Pub. No.: US 2020/0242094 A1
(43) Pub. Date: Jul. 30, 2020

(54) INFORMATION PROCESSING APPARATUS, COMPUTER-READABLE RECORDING MEDIUM HAVING STORED THEREIN INFORMATION PROCESSING PROGRAM, AND INFORMATION PROCESSING SYSTEM

(71) Applicant: FUJITSU LIMITED, Kawasaki-shi (JP)

(72) Inventor: Kazuhito MATSUDA, Kawasaki (JP)

(73) Assignee: FUJITSU LIMITED, Kawasaki-shi (JP)

(21) Appl. No.: 16/737,329

(22) Filed: Jan. 8, 2020

(30) Foreign Application Priority Data
Jan. 28, 2019 (JP) 2019-012310

(51) Int. Cl. G06F 16/22

(52) U.S. Cl. CPC G06F 16/2228

(57) ABSTRACT

An information processing apparatus includes: a memory; and a processor coupled to the memory, the processor being configured to execute a procedure including: receiving a storing request to store data into a key value store that stores a key and a value in association with each other; storing identification information allocated to the data and the data into the key value store; managing association information that associates identification information allocated to data received in a unit time and contents of the data received in the unit time; and generating an index of the key value store based on a retrieving request specifying a time point, the association information, and the data stored in the key value store, the retrieving request being a request to retrieve data from the key value store.

### CROSS-REFERENCE TO RELATED APPLICATION

This application is based upon and claims the benefit of priority of the prior Japanese Patent application No. 2019-012310, filed on Jan. 28, 2019, the entire contents of which are incorporated herein by reference.

### FIELD

The present invention relates to an information processing apparatus, a computer-readable recording medium having stored therein an information processing program, and information processing system.

### BACKGROUND

An IoT (Internet of Things) devices that performs observation or measurement (hereinafter collectively referred to as “observation”) of a sensor and the like used in IoT is installed near to an observation target, and transmits the result of the observation to one or more servers in a data center or the like.

The observation result is transmitted from the IoT device to the server directly through a network such as the Internet or through an edge computer installed near to (“edge”) the observation target and the network. In the server, the received (collected) observation results are used for various analyses and services.

The observation result may include a type (key) of information to be observed and a value of the information to be observed. Hereinafter, an observation result is sometimes referred to as a “key value”.

Each server stores multiple key values (key value groups) received from the IoT devices into a database (may also be referred to as DB, DataBase, and “data store”) such as a KVS (Key-Value Store). As the KVS system, a well-known distributed KVS system can be used.

In a distributed KVS system, the performance thereof can be linearly enhanced by increasing the number of nodes (hereinafter, sometimes referred to as “responsible nodes”) that is to carry out not only reading data from the KVS but also writing data into KVS.

This is because a distributed KVS system determines the responsible nodes for a key in an order not depending on the number of keys by using, for example, a Distributed Hash Tables (DHT), and levels the loads.

[Patent Document 1] Japanese Laid-open Patent Publication No. 2018-133037

Here, the server generates an index of accumulate data in a KVS by means of an index generation mechanism used in a common Relational. DB Management System (RDBMS) for a KVS system, and also performs a process responsive to a retrieving request, using the index. In the following explanation, an “index” is sometimes denoted as “IDX” (Index).

However, in a KVS system that accumulates key values groups from, for example, IoT devices, a variety of keys are written into the KVS at relatively high rates.

For this reason, for example, a process of generating an IDX increases the processing load of the processor and also increase the using size of the storage area for storing the IDX, so that a large amount of IDX calculation resource and storage area resource may be required.

### SUMMARY

According to an aspect of the embodiment, an information processing apparatus includes: a memory; and a processor coupled to the memory. The processor being configured to execute a procedure including: receiving a storing request to store data into a key value store that stores a key and a value in association with each other; storing identification information allocated to the data and the data into the key value store; managing association information that associates identification information allocated to data received in a unit time and contents of the data received in the unit time; and generating an index of the key value store based on a retrieving request specifying a time point, the association information, and the data stored in the key value store, the retrieving request being a request to retrieve data from the key value store.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically illustrating an example of the configuration of an IoT system according to one embodiment;

FIG. 2 is a block diagram schematically illustrating an example of the functional configuration of a KVS system according to one embodiment;

FIG. 3 is a diagram illustrating an example of entry information;

FIG. 4 is a diagram illustrating an example of data stored in a KVS;

FIG. 5 is a diagram illustrating an example of data stored in a UID (Unique Identifier) list;

FIG. 6 is a diagram illustrating an example of entry retrieving information;

FIG. 7 is a diagram illustrating an example of an IDX generating status;

FIG. 8 is a diagram illustrating an example of data stored in an IDX;

FIG. 9 is a block diagram schematically illustrating an example of the configuration relating to a registering process of an entry into a KVS cluster;

FIG. 10 is a diagram illustrating an example of a node list;

FIG. 11 is a block diagram schematically illustrating an example of the configuration relating to a retrieving process of an entry from a KVS cluster;

FIG. 12 is a diagram illustrating an example of an indexer list;

FIG. 13 is a block diagram schematically illustrating an example of the functional configuration focusing on control of a scale-out process in a KVS system according to one embodiment;

FIG. 14 is a flowchart illustrating an example of processing by a KVS system according to one embodiment;

FIG. 15 is a flowchart illustrating an example of processing by a KVS system according to one embodiment;

FIG. 16 is a flowchart illustrating an example of processing by a KVS system according to one embodiment;

FIG. 17 is a flowchart illustrating an example of an operation of an entry storing process;

FIG. 18 is a diagram illustrating an example of an operation of an entry storing process;

FIG. 19 is a flowchart illustrating an example of an operation of an entry retrieving process;

FIG. 20 is a diagram illustrating an example of an operation of an entry retrieving process and an IDX generating process;

FIG. 21 is a diagram illustrating an example of an operation of an entry retrieving process;

FIG. 22 is a flowchart illustrating an example of an operation of an IDX generating process;

FIG. 23 is a flowchart illustrating an example of an operation of a scale-out process; and

FIG. 24 is a block diagram schematically illustrating an example of the hardware configuration of a computer according to one embodiment.

### DESCRIPTION OF EMBODIMENTS

Hereinafter, an embodiment of the present invention will now be described with reference to the accompanying drawings. However, the embodiment described below is merely illustrative and is not intended to exclude the application of various modifications and techniques not explicitly described below. For example, the present embodiment can be variously modified and implemented without departing from the scope thereof. In the drawings to be used in the following description, like reference numbers designate the same or substantially same parts and elements, unless otherwise specified.

### (1) One Embodiment

An IDX generated by a typical RDBMS increases its IDX size as the amount of accumulated IDXes (indexes) increases, and the processing time for adding or deleting entries also increases as the amount of accumulated IDXes increases. For this reason, it is common to generate a small number of IDXes for a retrieving key that is not frequently updated.

On the other hand, it is assumed that an IoT device or the like has various keys according to, for example, type, installation location, and purpose of the device. In addition, it is assumed that an IoT device or the like writes a key value group into a KVS at a rate relatively higher than the rate assumed in a typical RDBMS or KVS system.

Therefore, in a distributed KVS system that accumulates a key value group from IoT devices or the like, various keys are written into KVS at high rates, and as described above, it is assumed that this raises the computation cost of IDXes and the cost of storage areas.

In many cases, a retrieving request for the data collected by IoT devices or the like are less frequently made as compared with the number of storage processes. Therefore, maintaining IDXes at all times as in a typical RDBMS is sometimes not suitable for a KVS system from the aspect of cost-effectiveness.

As a solution to the above, a method of reducing the resource amount for a generating process of an IDX for the data stored in the KVS system will be described as one aspect of an embodiment.

As another aspect of the embodiment, a method of providing a scalable mechanism in terms of the resource amount to a key value group generated by an IoT device or the like will be described.

[1-1] Configuration Example of One Embodiment:

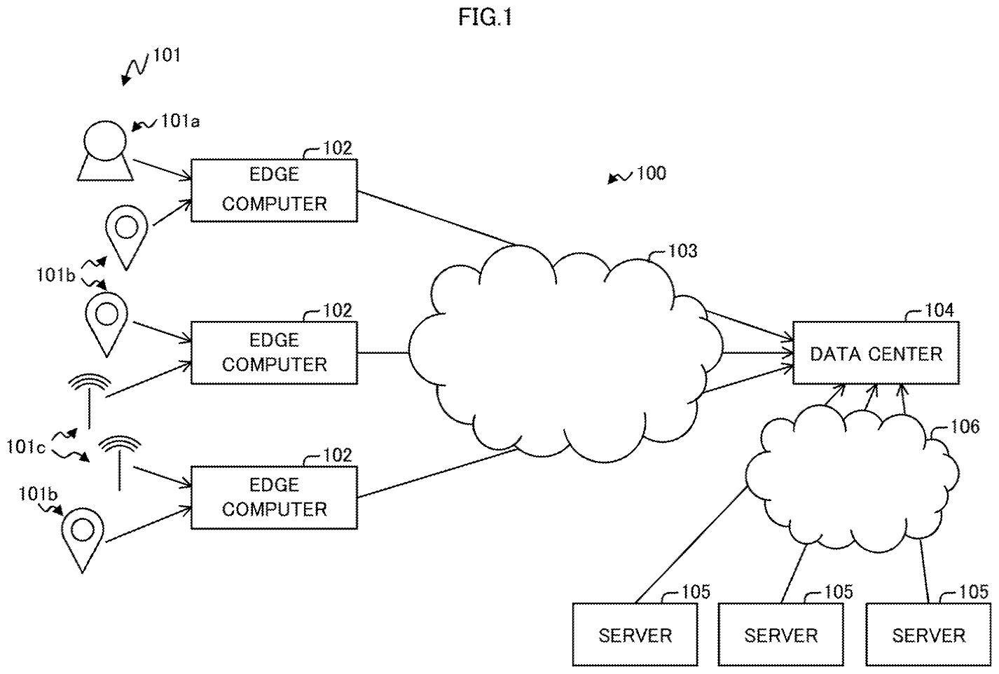

FIG. 1 is a block diagram schematically illustrating an example of the configuration of an IoT system 100 according to an example of one embodiment. As illustrated in FIG. 1, the IoT system 100 may exemplarily include multiple IoT devices 101, multiple edge computers 102, networks 103 and 106 such as the Internet, a data center 104, and multiple servers 105.

The IoT device 101 obtains the data by various methods and transmits registering requests containing the obtained data to the corresponding edge computer 102 to register the data into the data center 104. The IoT device 101 may transmit data to the edge computer 102 each time obtaining the data, or may accumulate data and transmit the accumulated data at regular time intervals. The IoT device 101 may transmit a registering request to the network 103 (data center 104) without using the edge computer 102.

Examples of the data that the IoT device 101 obtains include key values such as a result of observing an observation target, a result of an input from a user or the like, and a result of calculation on the input data. A key value may include the type (key) of information and the value of the information.

Examples of the lot device 101 include an information processing apparatus 101a, a positioning device 101b utilizing a satellite positioning systems such as GPS, and various sensors 101c. Examples of the information processing apparatus include a PC (Personal Computer), a smartphone, a tablet computer, and a mobile phone.

The IoT device may have a wireless or wired communication function, or may be connected to a communication device having the communication function.

The edge computer 102 is located near to (edge) an observation target, and transmits a registering request received from the IoT device 101 to the data center 104 through the network 103. The edge computer 102 may receive the data itself from the IoT device 101, generate a registering request including the received data, and transmit the generated registering request to the data center 104, on behalf of the IoT device 101.

The data center 104 is provided with multiple non-illustrated servers. The data center 104 receives a registering request transmitted from the IoT device 101, and stores data included in the received registering request into a database such as the KVS under control of the multiple servers. The data center 104 receives the retrieving request transmitted from the server 105, retrieves data satisfying the retrieving condition specified by the retrieving request from the DB, using the IDX, and responds to the source of the retrieving request with the search result under control of the multiple servers.

The multiple servers 105 reference data stored in the DB of the data center 104, e.g., a KVS, via the network 106 exemplified by the Internet. For example, the server 105 sends a retrieving request to the multiple servers of the data center 104, and receives the results of the retrieving from the multiple servers. The network 106 may be the same network as the network 103.

The multiple servers 105 may include computers of various information processing apparatuses, such as physical machines, virtual machines, or combinations thereof. The server 105 may reference data stored in the KVS serving as, for example, data for learning (e.g., Deep Learning) or analytics in artificial intelligence (AI). The data stored in the KVS may be data that is treated as so-called “big data”.

[1-2] Example of Functional Configuration:

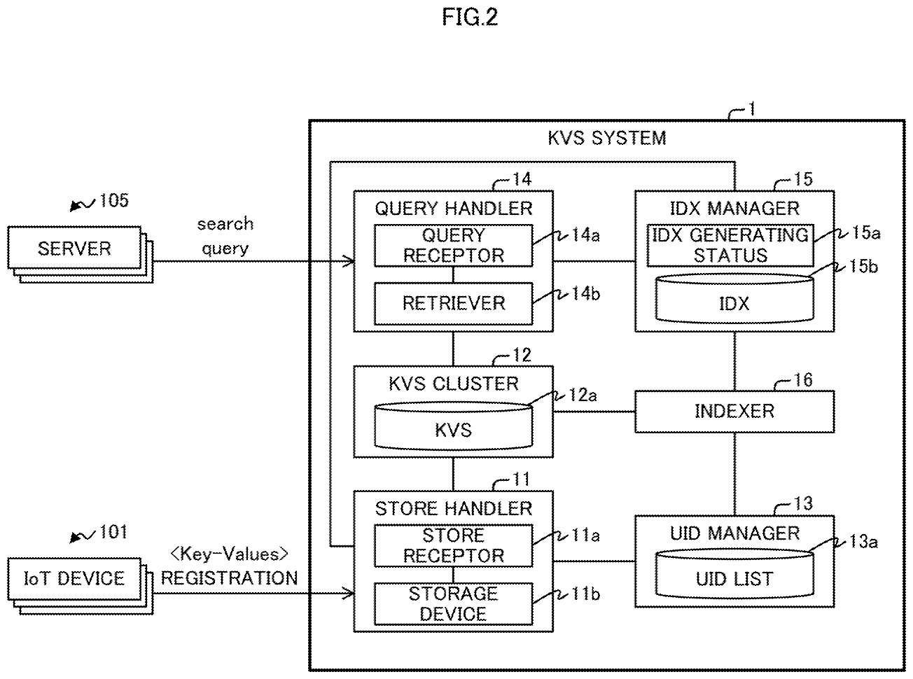

FIG. 2 is a block diagram showing an example of a functional configuration of the KVS system 1 according to an example of one embodiment. The KVS system 1 is an example of an information processing system, and the KVS system 1 may be achieved by multiple servers included in the data center 104 illustrated in FIG. 1, for example. Alternatively, the KVS system 1 may be achieved by one or more servers provided at a base such as a facility different from the data center 104.

Each of multiple servers provided in the data center 104 and/or the base may be a physical machine having, for example, a processor, a memory, a storing apparatus as will be described later. Such multiple servers, which are physical machines, may execute multiple virtual machines (VMs).

For example, in cases where the multiple servers provide a cloud system such as IaaS (Infrastructure as a Service), each virtual machine may be one provided by the cloud system.

Accordingly, the KVS system 1 may be implemented by multiple physical machines, multiple virtual machines, or a combination of one or more physical machines and one or more virtual machines.

As the KVS system 1, a distributed KVS system can be used.

As shown in FIG. 2, the KVS system 1 may illustratively include a store handler 11, a KVS cluster 12, a UID manager 13, a query handler 14, an IDX manager 15, and an indexer 16.

Each of the store handler 11, the KVS cluster 12, the UID manager 13, the query handler 14, the IDX manager 15 and the indexer 16 may be implemented by one or more nodes. The nodes include, for example, virtual machines or physical machines.

The KVS system 1 of one embodiment enables scale-out by a configuration described below. Scale-out enhance the overall performance of the KVS system 1 by introducing (adding) hardware (HW) resources and network (NW) resources to the KVS system 1.

In the KVS system 1 of one embodiment, the scale-out enables the storing performance and the retrieving performance of data with respect to the KVS to be enhanced in proportion to the size of the scale-out.

Examples of the HW resource include processors such as a Central Processing Unit (CPU), and a storing apparatus such as a memory, a Hard Disk Drive (HDD), and a Solid State Drive (SSD). Examples of the NW resource include bands (or bandwidths) of a communication line, and/or a communication device such as a router and a switch.

Hereinafter, the description made with reference to FIGS. 2 to 8 assumes the case where the functional blocks 11 to 16 are each realized by one node, for convenience.

The store handler 11 controls storing (registering and storing) of data into the KVS cluster 12. For example, the store handler 11 may function as a registration receipt Application Programming Interface (API) that accepts registration requests for registering data to the KVS cluster 12 from the IoT device 101. The store handler 11 may have a scale-out function that is able to increase or decrease the nodes in accordance with, for example, the processing load on the store handler 11.

As illustrated in FIG. 2, the store handler 11 may illustratively include a store receptor 11a as an example of the registration receipt API and a storage device 11b.

For example, the store receptor 11a receives a registering request (storing request) from the IoT device 101, and obtains, as a parameter, entry information (hereinafter, sometimes referred to as “entry”) including data to be registered into the KVS cluster 12 from the registering request. Then, the store receptor 11a outputs the obtained entry information to the storage device 11b.

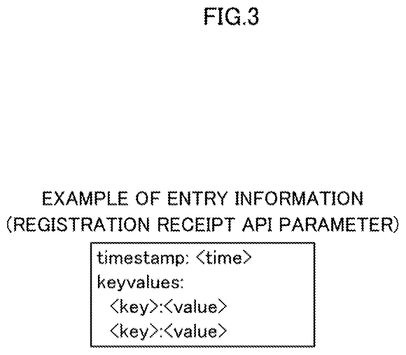

FIG. 3 is a diagram illustrating an example of entry information. As described above, in one embodiment, the KVS system 1 receives key values, such as observation results, as data, from the IoT device 101. Accordingly, in one embodiment, an entry includes a key value.

In the following description, the original “key”, “value”, and “key value” received from the IoT device 101 are sometimes referred to as “original key”, “original value”, and “original key value”, respectively.

Here, as illustrated in FIG. 3, the entry information may include a time stamp (timestamp).

In the time stamp, the time at which the IoT device 101 obtains or transmits data may be set by IoT device 101. In addition to or in lieu of the above time, the time when data is received by the KVS system 1 (store handler 11) or the time when data is stored into the KVS cluster 12 may be set by store receptor 11a.

The storage device 11b registers an entry into the KVS cluster 12 on the basis of the entry information accepted by the store receptor 11a.

For example, the storage device 11b may assign a unique ID (UID; Unique Identifier) to an entry that is to be registered into the KVS cluster 12 and that is included in the accepted entry information. The UID is an ID unique to the KVS system 1 (e.g., KVS cluster 12), and is an example of the “identification information”.

For example, the storage device 11b requests the UID manager 13 to issue a UID, and allocates (associates) the issued UID to (with) an entry to be registered, that is, to an original key value. The entry information may include multiple sets of original key values, as in cases where the IoT device 101 transmits a registering request at regular time intervals. In this case, the storage device 11b may allocate a single UID to multiple sets of the original key values, or may allocate a UID to each set of the original key values.

Here, the storage device 11b may transmit the entry information to the UID manager 13 along with the transmission of a request to issue a UID or after the UID is issued.

Furthermore, the storage device 11b may transmit a key value using a UID as a key and an entry to be registered as a value to the KVS cluster 12, and instructs the KVS cluster 12 to store the key value into the KVS 12a to be described below. The value of the key (UID) and value (entry) transmitted from the storage device 11b to the KVS cluster 12 is the “original key value” received from the IoT device 101.

As described above, the store handler 11 is an example of a storing processor that accepts (receives) a storing request of the data into the KVS 12a and stores the identification information allocated to the data and the data into the KVS 12a.

The KVS cluster 12 includes a KVS 12a, which is an example of a key value store that stores a key and a value in association with each other, controls reading and writing of data from and to the KVS 12a, and manages the KVS 12a.

The KVS cluster 12 may have a scale-out mechanism that enables the number of nodes to be increased or decreased in accordance with, for example, the processing load of the KVS cluster 12, the storage capacity (or empty space capacity) of the data in the KVS 12a by using a distributed hashing table (DHT).

For example, upon receiving an instruction to store a key value from the storage device 11b, the KVS cluster 12 stores the key value into the KVS 12a.

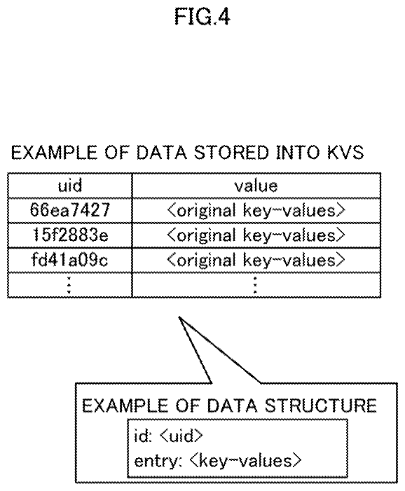

FIG. 4 is a diagram illustrating an example of data stored in the KVS 12a. As illustrated in FIG. 4, the KVS cluster 12 stores the UID, which is a key related to a storing instruction, and the entry (original key value), which is a value related to the storing instruction, into the KVS 12a.

The KVS 12a may be implemented by a storage area of the node implementing the KVS cluster 12. In FIG. 4, the data stored in the KVS 12a is represented in a table form for the sake of convenience, but the data form is not limited to this. The KVS cluster 12 may store data in the KVS 12a in various forms such as a DB format, or an XML (eXtensible Markup Language) format.

Furthermore, when receiving an extracting request (retrieving request) specifying a UID as a retrieving key from one of a query handler 14, an IDX manager 15 and an indexer 16 that are to be described below, the KVS cluster 12 extracts an entry, which is a value associated with the specified UID, from the KVS 12a. The KVS cluster 12 replies to the source of the extracting request with the extracted entry.

The UID manager 13 is an example of a manager that issues UIDs and manages the UID list 13a. For example, in managing the UID list 13a, the UID manager 13 adds data to the UID list 13a, extracts data from the UID list 13a, and the like.

Here, the UID manager 13 may have a scale-out mechanism that enables the number of nodes to be increased or decreased in accordance with, for example, processing load on the UID manager 13.

In response to a request to issue a UID from the storage device 11b, the UID manager 13 issues a UID, which is univocal in the KVS-system 1 (KVS 12a), to the storage device 11b. The determination of the UID can be accomplished by various known methods, such as calculation in conformity with a given rule or extraction from a given list.

Upon receiving an entry from the storage device 11b, the UID manager 13 generates a list based on the original key and the time stamp in the received entry and the UID issued for the entry, and stores the list into the UID list 13a.

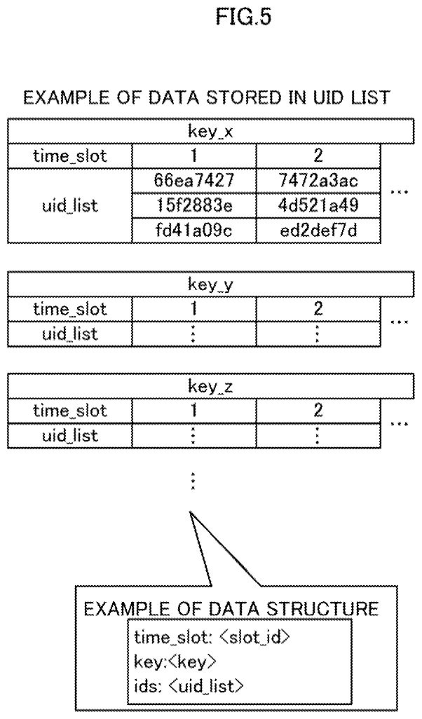

FIG. 5 is a diagram illustrating an example of data stored in the UID list 13a. The UID list 13a may be information stored in a storage area of the node implementing the UID manager 13. In FIG. 5, the UID list 13a is illustrated in a table form for convenience, but the data form is not limited to this. Alternatively, the UID list 13a may be stored in the storage area of the node in various forms such as a database form, a sequence, and an XML form.

The UID list 13a is information to manage the UID of an entry received in each time slots (TS; time_slot). The TS is an example of a unit time or a predetermined time period, and each TS may correspond to a predetermined time range (from the start time to the end time). A TS may be, for example, from one hour to several days, and in one embodiment, is assumed to be “one day”. The length of the TS (TS length, TS interval) may be variable as described below.

The UID list 13a may, for example, have a list for each original key. In the example of FIG. 5, “key_x”, “key_y”, “key z” . . . , indicates the original keys.

In the examples of FIG. 5, focusing on the original key “key_x”, it can be understand that the UIDs of the entries received during the time period of “time_slot=1” and including the original key “key_x” are “66ea7427”, “15f2883e”, and “fd41a09c”.

As described above, the UID list 13a makes it possible to specify a retrieving key (UID) for retrieving an entry including a particular original key from the KVS 12a in units of TS.

In other words, the UID list 13a is an example of association information that associates the identification information allocated to the data received in a unit time with the content of the data received in the unit time.

For example, the UID manager 13 may reference an original key included in the entry information received from the storage device 11b. In addition, the UID manager 13 may reference the time stamp included in the entry information received from the storage device 11b and specify the TS to which the time stamp belongs. The UID manager 13 specifies a list associated with the referenced original key and the specified TS in the UID list 13a, and sets (stores) the UID allocated to the entry into the list.

In the above description, the time point indicated by the time stamp is treated as the time point at which the store receptor 11a receives the entry from the IoT device 101. This is because, for example, in cases where the time point at which the IoT device 101 obtained or transmitted the data is set as the time stamp, the difference between the time point indicated by the time stamp and the time point at which the entry was received is small enough to be regarded as the same.

However, the time stamp is not limited to this, and in one embodiment, the store receptor 11a may sufficiently set the time point at which data was received from the IoT device 101 to the time stamp of the received data, for example, as described above, so that the above “difference” do not occur.

The query handler 14 is an example of the retrieving receptor that controls retrieval of data from the KVS cluster 12. For example, the query handler 14 may function as a retrieval receipt API that accepts retrieving request of data from the server 105 to the KVS cluster 12. The query handler 14 may have a scale-out mechanism that allows the number of node to be increased or decreased in accordance with, for example, the processing load on the query handler 14.

The query handler 14 may illustratively include a query receptor 14a, which is an example of the retrieval receipt API, and a retriever 14b.

For example, the query receptor 14a receives a retrieving request from the server 105, obtains, as a parameter, entry retrieving information including a retrieving condition, which is a condition for retrieving from the KVS cluster 12, from the retrieving request, and outputs the obtained entry retrieving information to the retriever 14b.

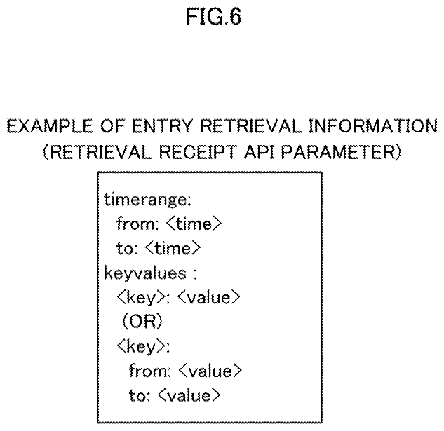

FIG. 6 is a diagram illustrating an example of entry retrieving information. As exemplarily illustrated in FIG. 6, the entry retrieving information may include, as a retrieving condition, a time range (timerange), a retrieving key, and a retrieving value.

The time range may include at least one of a start time point and an end time point of the retrieving target. The retrieving key and the retrieving value may include at least one of an original key of the retrieving target, an original value of the retrieving target, and a range of the original value of the retrieving target. The range of the original value may include at least one of a start value and an end value of the retrieving target.

The retriever 14b transmits an retrieving request of the entry from the KVS cluster 12 on the basis of the entry retrieving information received from the query receptor 14a, and, upon receiving the result of the retrieving from the KVS cluster 12, replies the server 105, which is the sender of the retrieving request, with the result of the retrieving.

For example, the retriever 14b may specify a TS to be retrieved on the basis of the time range included in the retrieving condition. The retriever 14b may send the IDX manager 15 a request to obtain the UID list, which request includes the entry retrieving information and the specified TS. Upon receipt of the UID list from the IDX manager 15, the retriever 14b may send a retrieving request for the value (original key value) to the KVS cluster 12, which request includes the received UID list. The retriever 14b receives, as a result of the retrieving, the value (original key value) associated with the key (UID) specified by the UID list from the KVS cluster 12.

The IDX manager 15 manages an IDX generating status 15a and an IDX 15b, performs processes responsive to a request from the query handler 14, extracts IDX data from the IDX 15b, controls the operation of the indexer 16, and the like.

The IDX manager 15 may have a scale-out mechanism that allows the number of nodes to be increased or decreased in accordance with, for example, the processing load on the IDX manager 15 or the indexer 16.

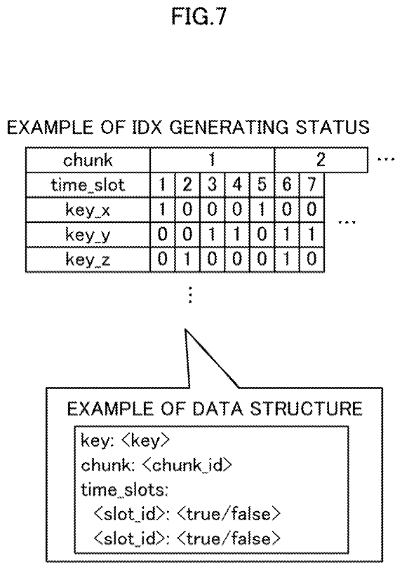

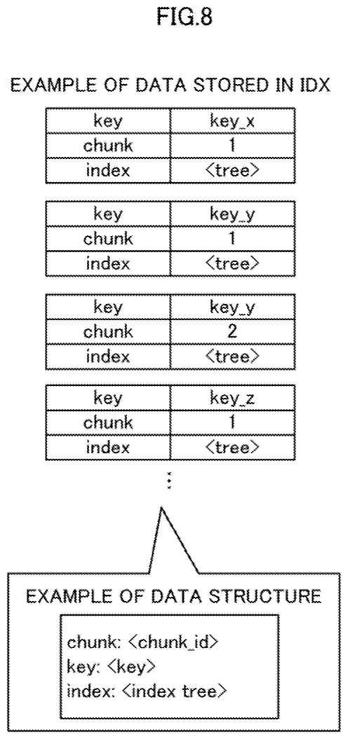

FIG. 7 is a diagram illustrating an example of data stored in the IDX generating status 15a, and FIG. 8 is a diagram illustrating an example of data stored in the IDX 15b. Each of IDX generating status 15a and IDX 15b may be information stored in a storage area of the node implementing the IDX manager 15. in FIG. 7 and FIG. 8, the IDX generating status 15a and the IDX 15b are each represented in a table form for convenience, but the data form is not limited to this. For example, the IDX generating status 15a and the IDX 15b may be stored in storage areas of nodes in various forms such as a DB form, a sequence, an XML format, and bitmap format.

The IDX generating status 15a is information for managing the status of generating IDX data for each original key. As illustrated in FIG. 7, in the IDX generating status 15a, the validity or invalidity of the IDX data may be set for each also TS and for each original key, for example. As an example, as illustrated in FIG. 7, “1” (or “true”) indicating that the IDX data is valid (generated) is set to “time_slot (time_slot_id)”=“1” and “5” of “key_x”.

In addition, “0” (or “false”) indicating that the IDX data is invalid (not generated) is set to “time_slot (time_slot_id)”=“2”, “3” and “4” of “key_x”.

Here, in one embodiment, the generation of the IDX data may be performed in units of chunk (chunk).

A “chunk” is an example of a given time period in which multiple successive (five in the example of FIG. 7) TSs are bundled as one unit. This is because a retrieving request for the data collected by the IoT device 101 has locality, e.g., temporal locality.

In the example of FIG. 7, since “time_slot”=“1” and “5” of “key_x” are set to “1”, the IDX data of “key_x” in a period of “chunk (chunk_id)”=“i” (period of “time_slot”=“1” to “5”) is generated in IDX 15b. When “0” is set in all TSs belonging to a chunk in IDX generating status 15a, the IDX data of the chunk is not generated in IDX 15b.

As described above, the IDX generating status 15a is an example of generating management information indicating whether or not the IDX data of the data received in each TS included in the chunk is included in the IDX 15b of the chunk.

By generating IDX data in units of chunk, it is possible to suppress an increase in the number of IDX trees in the IDX 15b, and to enhance the scan (reference) efficiency of the IDX 15b, as compared with generating the IDX data on in units of TS.

The length of the chunk (the chunk length and the chunk interval) may be variable. For example, the number of TSs to be included may be set to be different for each chunk. Alternatively, by variably setting the TS length as described above, the chunk length may be adjusted. Alternatively, both of the chunk length and the TS length may be variably set. Adjustments (increase and decrease) of the chunks length and the TS length may be controlled by the IDX manager 15.

As described above, the examples shown in FIG. 7 represents that the IDX data of “key_x” in the chunk “1” among the IDX data included in the IDX 15b includes entries received during the periods of “time_slot”=“1” and “5”. In other words, among the IDX data included in the IDX 15b, the IDX data of “key_x” in the chunk “1” does not include entries received during the periods of “time_slot”=“2” to “4”.

As illustrated in FIG. 8, the IDX 15b of one embodiment may include IDX data in units of chunk, for one original key. In the case of FIG. 8, a set of a “key”, a “chunk (chunk_id)” and an “index” corresponds to the IDX data. In an “index”, a tree (IDX tree) for retrieving a UID allocated to (associated with) the original value from the original value is set. The data structure of the IDX tree may, for example, be the same as the IDX tree of the RDBMS.

The IDX manager 15 may manage the using status of the IDX 15b by, for example, a Least Recently Used (LRU) algorithm, and may delete IDX data in units of chunk in accordance with the requirements for the size of the IDX 15b size, for example.

Upon receipt of a request to obtain a UID list from the query handler 14, the IDX manager 15 may refer to the IDX generating status 15a and determine the presence or absence of IDX data for extracting the UID list on the basis of the retrieving key and the time range included in the entry retrieving information.

In cases of determining that the IDX data for extracting UID lists has not been generated, the IDX manager 15 performs a generating processing (IDX generating processing) of the IDX data not having been generated yet in cooperation with indexer 16. In other words, in cases where the IDX data relating to the data received in the TS corresponding to the time specified by the retrieving request is not included in the IDX 15b, the IDX manager 15 adds the IDX data to the IDX 15b in the IDX generating process.

When the IDX generating process is completed, the IDX manager 15 may set “1” indicating validity to the TS for which the IDX data is generated and the retrieving key (original key) for which the IDX data is generated in the IDX generating status 15a.

In cases of determining that the IDX data has been generated, or in cases of having performed the IDX generating process, the IDX manager 15 scans (refers to) IDX 15b for all the retrieving keys included in the retrieving condition, and obtains (extracts) the UIDs of one or more entries matching the retrieving condition.

Then the IDX manager 15 transmits a list of obtained UIDs (UID list) to the query handler 14 in response to the obtaining request.

The indexer 16 performs the following IDX generating process in cooperation with the IDX manager 15. The indexer 16 may have a scale-out mechanism that allows the number of nodes to be increased or decreased in accordance with, for example, the processing load on the IDX manager 15 or the indexer 16.

In the IDX generating process, the IDX manager 15 obtains the UID list of an entry group having a retrieving key for which IDX data is to be generated in a TS for which IDX data is generated, from the UID manager 13 through, for example, the indexer 16. Then the IDX manager 15 instructs the indexer 16 to generate IDX data based on the obtained UID list.

In response to the instruction from the IDX manager 15, the indexer 16 transmits, to the KVS 12a, a request for retrieving an entry from the KVS 12a using a UID included in the UID list as a retrieving key.

The indexer 16 receives an entry of the retrieving result from the KVS cluster 12, and generates (adds) the IDX data based on the received entry in (into) the IDX 15b. This completes the IDX generating process.

As described above, the IDX manager 15 and indexer 16 are examples of a generator that generates the IDX 15b of the KVS 12a on the basis of the retrieving request specifying a time point, the UID list 13a, and the data that the KVS 12a stores. This generator extracts identification information associated with the time point specified by a retrieving request from the UID list 13a, extracts data associated with the extracted identification information from KVS 12a, and generates the IDX data of the IDX 15b on the basis of the extracted identification information and the extracted data.

As described above, the KVS system 1 according to one embodiment performs the IDX generating process in cases where the KVS system 1 has received the retrieving request for an entry and has not generated IDX data corresponding to the retrieving condition.

This brings the following advantages as compared with the conventional method of generating (updating) an IDX when an entry is stored into the KVS as performed in the cases of using an IDX generated by a typical RDBMS.
Even if a key value group is written from the IoT device 101 to the KVS 12a at a high frequency, the IDX generating process is not performed when the entries are stored into the KVS 12a, and therefore, it is possible to suppress increases in processing load and processing time of the IDX generating process. Consequently, it is possible to suppress increases in the processing load and processing time of the entry storing process into the KVS 12a.
Since generating the IDX data relating to a retrieving key specified by the retrieving condition from the server 105 in response to the retrieving request, the IDX manager 15 and the indexer 16 do not need to generate unnecessary IDX data and can suppress an increase in the size of the storage area used for the IDX 15b.
Since the IDX data is managed in units of chunk and unused IDX data is deleted in units of chunk, it is possible to suppress an increase in the size of the storage area used for IDX 15b.

As described above, according to the KVS system 1 of one embodiment, the amount of resources of the process of generating IDXes for the data stored in the KVS 12a can be reduced. Accordingly, for example, the process time and the process performance not depending on an amount of the key value group registered in the KVS 12 enables the storage and the retrieval of a key value group in and from the KVS 12a.

In the above description, the KVS system 1 according to one embodiment is assumed to perform the IDX generating process in cases where the retrieving request of an entry has been received and the IDX data matching the retrieving condition has not been generated, but the KVS system 1 is not limited to this.

For example, the IDX generating process may be allowed to be performed at the timing of storing where a UID and an entry are stored into the KVS 12a.

For example, when storing a key value into the retriever 14b, the KVS system 1 may refer to the IDX generating flag to determine whether or not the IDX generating flag is valid. In cases where the IDX generating flag is valid, the KVS system 1 may instruct the IDX manager 15 to perform the IDX generating process.

The IDX generating flag is information specifying whether or not to perform the IDX generating process at the timing of storing a key value into the KVS 12a (in other words, each time a key value is stored), and may be set in advance in the KVS system 1 by, for example, a user or an administrator of the KVS system 1. The IDX generating flag may be referenced and determined by the store handler 11, the KVS cluster 12, or the IDX manager 15, for example.

[1-3] Configuration Example for Scale-Out:

The above description focuses on the processes of storing an entry into the KVS 12a, generating IDX data, and retrieving IDX data from the KVS 12a in the KVS system 1. In addition to the above-described configuration, the KVS system 1 according to one embodiment can easily achieve scale-out by including the following configuration.

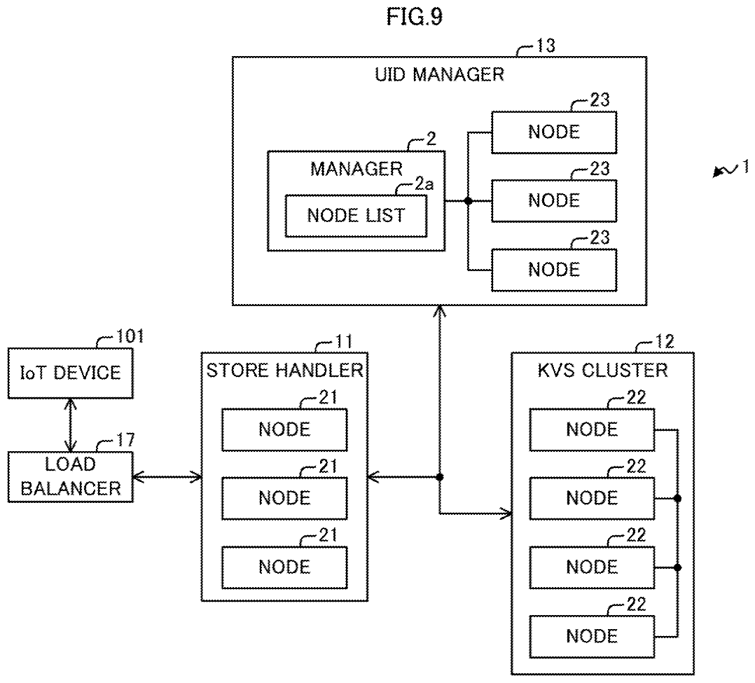

Hereinafter, description will now be made in relation to a configuration focusing on the scale-out function in the KVS system 1 with reference to FIG. 9 to FIG. 12.

FIG. 9 is a block diagram schematically illustrating an example of the configuration of the registering process of entries into the KVS cluster 12. In FIG. 9, the illustrations of the query handler 14, the IDX manager 15 and the indexer 16 of the KVS system 1 and the illustrations of the KVS 12a of the KVS cluster 12 and the UID list 13a of the UID manager 13 are omitted.

As illustrated in FIG. 9, the KVS system 1 may include a load balancer 17 in addition to the configuration of FIG. 2. The functions of the store handler 11, the KVS cluster 12, and the UID manager 13 may be achieved by multiple nodes 21 (three nodes in the example of FIG. 9), multiple nodes 22 (four nodes in the example of FIG. 9), and a plurality of nodes 23 (three nodes in the example of FIG. 9), respectively. Further, the UID manager 13 may include a manager 2.

The load balancer 17 performs load balancing by transmitting a registering request received from the IoT device 101 to one of the multiple nodes 21 in accordance with the respective processing loads (Load) of the multiple nodes 21.

Each of multiple nodes 21 may have a function as the store handler 11 illustrated in FIG. 2. This means that, even if any of the nodes 21 receives the registering request from the load balancer 17, the node 21 can accomplish the process as the above store hander 11.

The multiple nodes 22 have scale-out mechanisms with, for example a DHT, and achieve the functions of the KVS cluster 12 and the KVS 12a illustrated in FIG. 2.

Each of the multiple nodes 23 may have a function of the UID manager 13 illustrated in FIG. 2, and may distributedly manage UID list 13a among the plurality of nodes 23.

The manager 2 determines a node 23 that performs (is responsible for) registering (updating) process in accordance with the processing load of each of the nodes 23 for a registering (updating) process of a UID in the UID list 13a. In this manner, the manager 2 performs load-balancing on multiple nodes 23. The manager 2 itself may also be one or more nodes.

The manager 2 may manage a node list 2a for managing nodes 23, as illustrated in FIG. 9. For example, the manager 2 may allocate a node 23 to record a UID list for each original key.

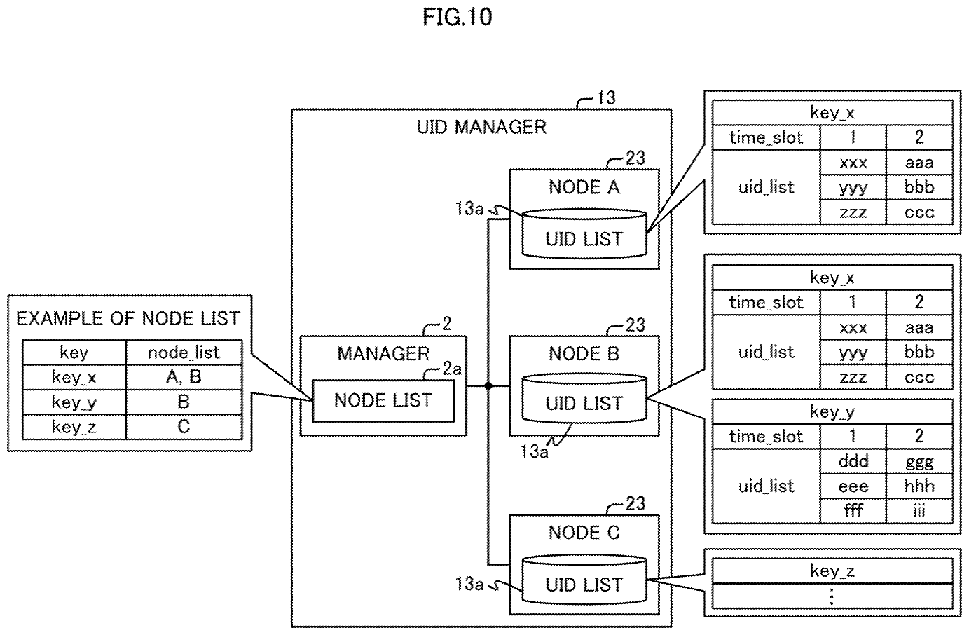

FIG. 10 is a diagram illustrating an example of the node list 2a. As illustrated in FIG. 10, the node list 2a may be information for managing the nodes 23 that record the UIDs of original keys. Here, two or more nodes 23 may be assigned to one original key.

In the example of FIG. 10, a node A and a node B (see FIG. 10) among the multiple nodes 23 are allocated to the original key “key_x”, and the node B is allocated to the original key “key_y”.

As described above, the KVS system 1 of one embodiment can adopt a configuration capable of load-balancing in each of the store handler 11, the KVS cluster 12 and the UID manager 13 that deal with the registering process of an entry.

Accordingly, for example, the function as the store receptor 11a by the store handler 11 can be executed in parallel by the multiple nodes 21 (in other words, multiple hosts). In addition, the function as the storage device 11b by the store handler 11 can be executed in parallel by the multiple nodes 21.

The KVS 12a can improve the write performance and the read performance substantially linearly by adding the nodes 22 (hosts).

Further, for example, the recording process of UIDs of the entries for respective TSs into the UID list 13a can be executed in parallel by the multiple nodes 23, in other words, multiple hosts.

As a result, the scale-out of the KVS system 1 can be easily achieved, so that the storage performance of data into the KVS can be improved in proportion to the extent of the scale-out.

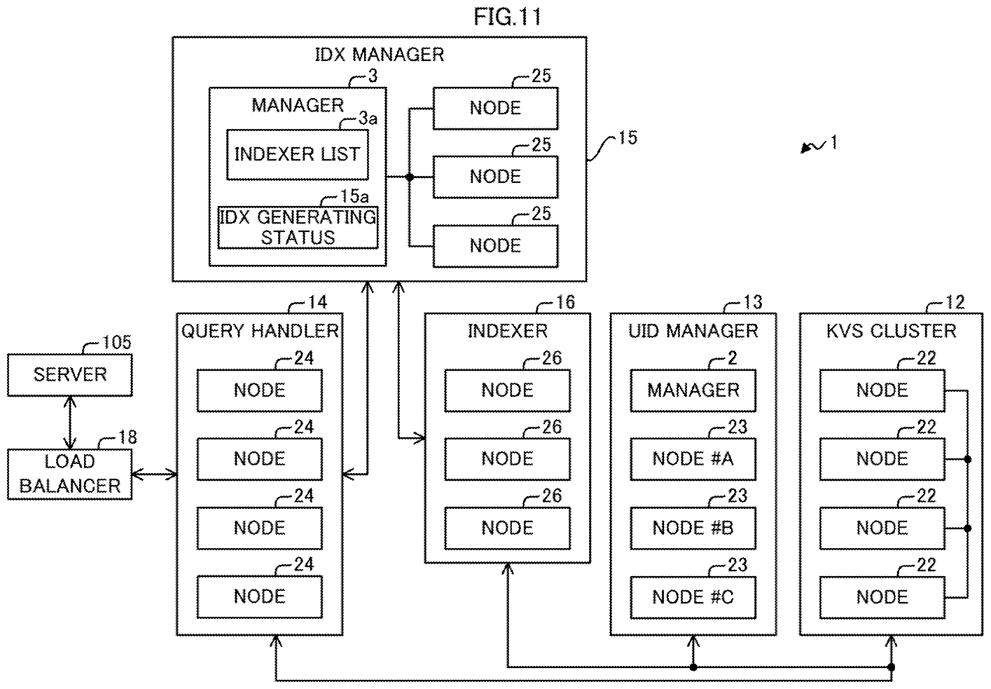

FIG. 11 is a block diagram schematically illustrating an example of the configuration of a retrieving process of an entry from the KVS cluster 12. In the example of FIG. 11, the illustration of the store handler 11 in the KVS system 1, and the illustration of the KVS 12a in the KVS cluster 12, the UID list 13a in the UID manager 13, and the IDX 15b in the IDX manager 15 are omitted.

As illustrated in FIG. 11, the KVS system 1 may include a load balancer 18 in addition to the configuration illustrated in FIGS. 2 and 9. The functions of the query handler 14, the IDX manager 15, and the indexer 16 may be achieved by multiple nodes 24 (four nodes in the example of FIG. 11), multiple nodes 25 (three nodes in the example of FIG. 11), and multiple nodes 26 (three nodes in the example of FIG. 11), respectively. Further, the IDX manager 15 may include a manager 3.

The load balancer 18 performs load balancing by transmitting the retrieving request received from the server 105 to one of the multiple nodes 24 in accordance of the processing load of each nodes 24. Here, the load balancer 17 and 18 may be implemented by the same information processing apparatus or communication device, e.g., a node, for example.

Each of the multiple nodes 24 may have the function as the query handler 14 illustrated in FIG. 2. In other words, even if any of the nodes 24 receives the retrieving request from the load balancer 18, the node can perform the above-described process as the query handler 14.

Each of the multiple nodes 25 may have the function of the IDX manager 15 illustrated in FIG. 2, and may distributedly manage the IDX 15b among the multiple nodes 25.

Each of the multiple nodes 26 may have the function as the indexer 16 illustrated in FIG. 2. That is, any of the nodes 26 can perform the IDX generating process.

The manager 3 determines a node 25 and a node 26 that perform (is responsible for) management of IDX data and an IDX generating process in accordance with, for example, the processing loads of the IDX generating process by each of the multiple nodes 25 and 26. In this manner, the manager 3 performs load-balancing of the multiple nodes 25 and the multiple nodes 26. The manager 3 itself may also be one or more nodes.

For example, the manager 3 may allocate nodes 25 and 26 that perform management of IDX data and the IDX generating process for each chunk and also for each original key. The manager 3 may manage an indexer list 3a for managing the nodes 25 and the nodes 26, as illustrated in FIG. 11.

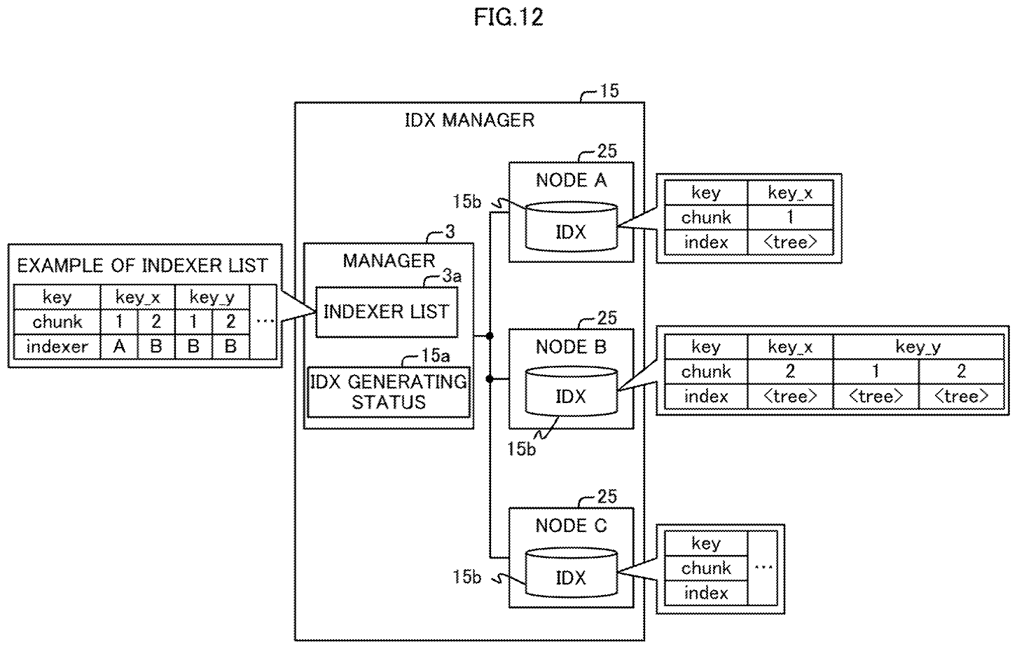

FIG. 12 is a diagram illustrating an example of the indexer list 3a. As illustrated in FIG. 12, the indexer list 3a may be information for managing the nodes 25 and 26 that manage the IDX data of each original keys in units of chunk. Multiple chunks and multiple original keys may be assigned to a set of the nodes 25 and 26.

In one embodiment, the node 25 and the node 26 may correspond to each other on the one-to-one, one-to-multiple, or multiple-to-one basis. In the example of FIG. 1.2, it is assumed that the node 25 and the node 26 correspond to each other on a one-to-one basis, and the node A, the node B, and the node C of the multiple nodes 25 correspond to the node A, the node B, and the node C (all of which are not illustrated) of the multiple nodes 26, respectively.

In the example of FIG. 12, the node A is allocated to the original keys “key_x”, “chunk_id”=“1”, and the node B is allocated to “key_x”, “chunk_id”=“2”.

Node B is allocated to “key_y” and “chunk_id”=“1”, and node B is allocated to “key_y” and “chunk_id”=“2”.

As described above, the KVS system 1 of one embodiment can adopt a configuration capable of load-balancing in each of the query handler 14, the IDX manager 15, and the indexer 16 that deal with the entry retrieving process and the IDX generating process.

Accordingly, for example, the function as the query receptor 14a by the query handler 14 can be executed in parallel by multiple nodes 24 (i.e., multiple hosts). The function as the retriever 14b by the query handler 14 can be executed in parallel by the multiple nodes 24.

For example, the IDX manager 15 can manage the IDX data of each chunk by the different nodes 25 and 26 (i.e., the hosts) in units of chunk.

This makes it possible to easily achieve the scale-out of the KVS system 1, so that the retrieving performance of data from the KVS can be improved in proportion to the extent of the scale-out.

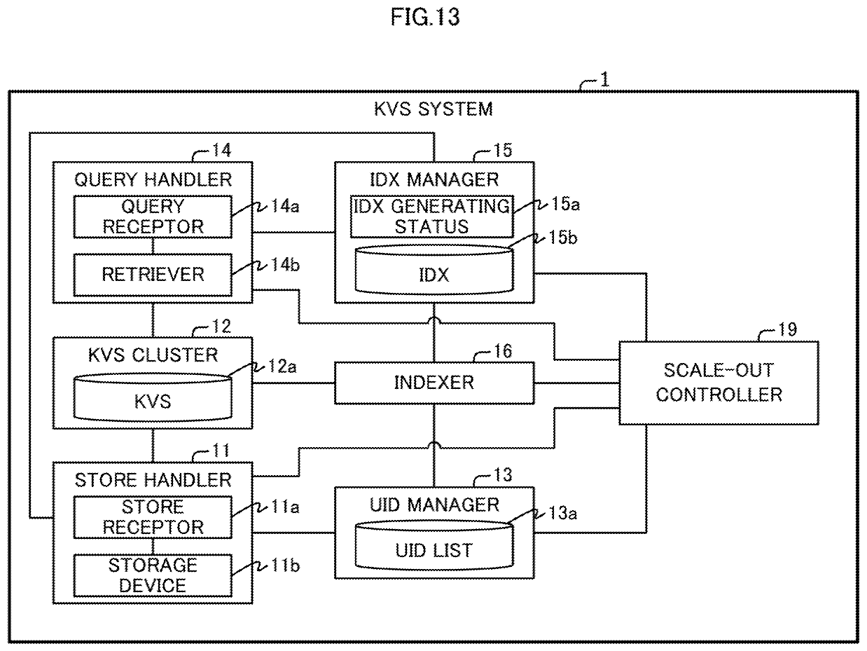

Here, as illustrated in FIG. 13, the KVS system 1 of one embodiment may include a scale-out controller 19 for analyzing a bottleneck point and controlling execution of a scale-out process according to the bottleneck point, in addition to the configuration illustrated in FIG. 2 and FIGS. 9 to 12.

The scale-out controller 19 is an example of a monitor that monitors the performance of the KVS system 1, and may analyze a bottleneck in the KVS system 1 at a given timing. The “performance” to be monitored by the scale-out controller 19 includes, for example, the processing performance (e.g., the usage rates and the processing time of the processors and the memories) of the nodes such as the store handler 11, the UID manager 13, the query handler 14, the IDX manager 15. The “performance” to be monitored may include, for example, the number of storing requests and/or retrieving requests to the KVS system 1.

At a given timing, the scale-out controller 19 compares results of monitoring various performances with given threshold values corresponding to the types of performance, and identifies a node whose performance exceeds the given threshold value as a bottleneck point. The scale-out controller 19 instructs the specified bottleneck point to execute a scale-out process. In other words, based on the result of monitoring the performance, the scale-out controller 19 transmits a trigger to execute a scale-out process to the bottleneck point.

As one example, in cases where the bottleneck point is the store handler 11 or the query handler 14, the scale-out controller 19 may send an instruction to the store handler 11 or the query handler 14, which is a bottleneck point, to increase the number of nodes 21 or 24. The store handler 11 or the query handler 14 may increase the number of nodes 21 or 24 in response to receiving the instruction.

In case where the bottleneck point is a process of updating the UID list 13a of the UID manager 13, the scale-out controller 19 may send the UID manager 13 an instruction to increase the number of nodes 23. In response to receiving the instruction, the UID manager 13 may increase the number of nodes 23, and may distributedly store the UID list 13a into the nodes 23 for each of the original keys on the basis of the result of monitoring. For example, the UID manager 13 may distribute a request (UID list 13a) of an original key frequently stored to the multiple nodes 23 on the basis of the result of the monitoring.

In addition, in cases where the bottleneck point is an updating process in the IDX 15b, the scale-out controller 19 may send the IDX manager 15 and/or the indexer 16 an instruction to increase the number of nodes 25 and/or 26. In response to receiving the instruction, the IDX manager 15 and/or the indexer 16 may increase the number of nodes 25 and/or 26, and may distributedly store the IDX 15b into the nodes 25 and/or 26 for each of the original keys on the basis of the result of the monitoring. The IDX manager 15 may reduce the chunk length of the key frequently retrieved.

As the above, the scale-out controller 19 performs control to change the number of nodes of at least one of the nodes 21, 22, 23, 24, and 25 and 26 on the basis of the result of the monitoring.

As described above, the scale-out controller 19 can flexibly carry out the scale-out of the KVS system 1 in accordance with the result of monitoring the performance. Since the scale-out is performed according to the bottleneck point, the HW resource and the NW resource can be efficiently used.

The scale-out controller 19 may be implemented as, for example, at least one of the functions as the store handler 11, the UID manager 13, the query handler 14, and the IDX manager 15 illustrated in FIG. 2. In other words, at least one of the store handler 11, the UID manager 13, the query handler 14, and the IDX manager 15 may have the function of the scale-out controller 19. Alternatively, the scale-out controller 19 may be implemented by one or more nodes different from the nodes 21-26 (see FIGS. 9 and 11).

[1-4] Example of Operation:

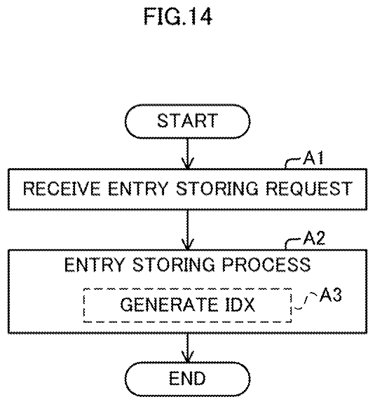

Next, description will now be made in relation to an example of an operation of the KVS system 1 according to one embodiment as described above with reference to FIGS. 14 to 23.

[1-4-1] Overall Process:

First, the overall process by the KVS system 1 will be described with reference to FIG. 14 to FIG. 16.

(A Case where a Storing Request of an Entry is Received)

As illustrated in FIG. 14, when the store receptor 11a of store handler 11 receives a storing request of an entry from the IoT device 101 (Step A1), the store receptor 11a obtains the entry information as a parameter and outputs the entry information to the storage device 11b.

The storage device 11b performs an entry storing process into the KVS cluster 12 on the basis of the entry information (Step A2), and the process ends.

The store handler 11 or the KVS cluster 12 may refer to the IDX generating flag in the entry storing process, and in cases where the IDX generating flag is valid, instruct the IDX manager 15 to execute the IDX generating process (Step A3). The IDX manager 15 may refer to the IDX generating flag.

(A Case where a Retrieving Request of an Entry is Received)

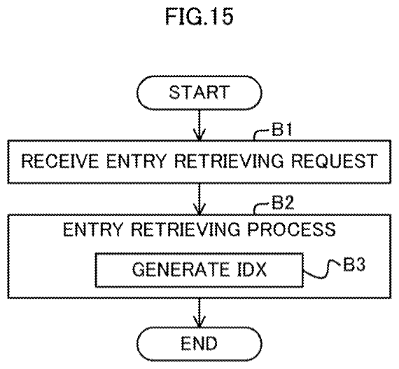

As exemplarily illustrated in FIG. 15, in cases where the query receptor 14a of the query handler 14 receives a retrieving request for an entry from the server 105 (Step B1), the query receptor 14a obtains the entry retrieving information as a parameter and outputs the entry retrieving information to the retriever 14b.

The retriever 14b performs the entry retrieving process from the KVS cluster 12 on the basis of the entry retrieving information (Step B2), and the process ends.

In the entry retrieving process, the IDX manager 15 and the indexer 16 sometimes perform the IDX generating process (Step B3).

(Cases where a Scale-Out Process is Performed)

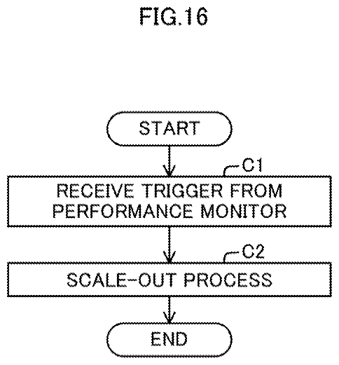

As exemplarily illustrated in FIG. 16, the scale-out controller 19 monitors the performance of the KVS system 1, and specifies the bottleneck point based on the result of monitoring the performance. Then, the scale-out controller 19 transmits a trigger for executing the scale-out process to the specified bottleneck point.

When the bottleneck point receives the execution trigger transmitted from the scale-out controller 19 as described above (Step C1), the bottleneck point executes the scale-out process (Step C2), and the process ends. Examples of the bottleneck point include the store handler 11, the UID manager 13, the query handler 14 and the IDX manager 15.

[1-4-2] Entry Storing Process:

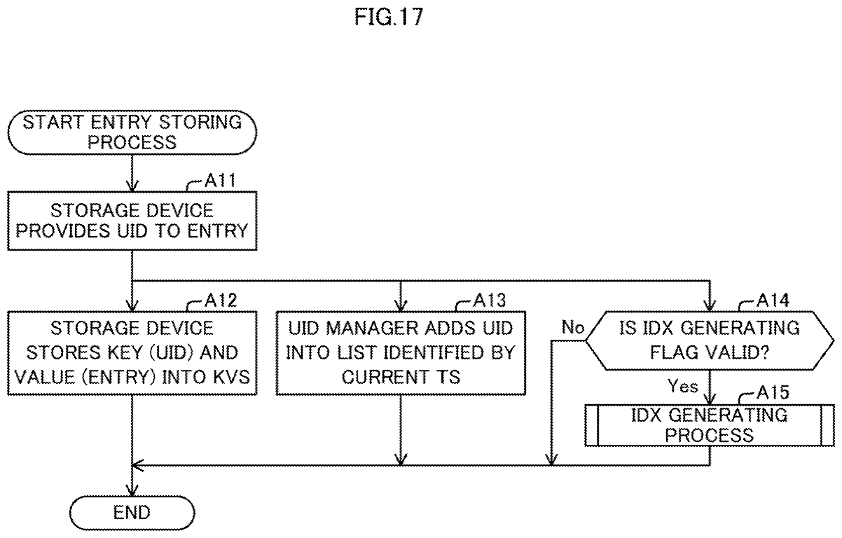

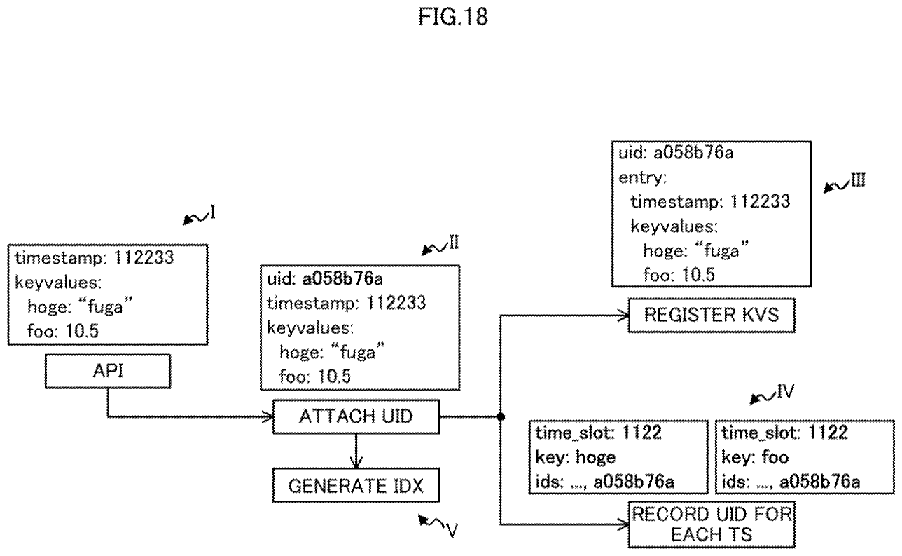

Next, description will now be made in relation to an example of operation of the entry storing process illustrated in Step A2 of FIG. 14 with reference to FIGS. 17 and 18.

As illustrated in FIG. 17, when receiving the entry information from the store receptor 11a, the storage device 11b requests the UID manager 13 to issue a UID. The storage device 11b assigns the issued UIDs to an entry to be registered (Step A11).

In the example of FIG. 18, the store receptor 11a as the registration receipt API obtains entry information of the time stamp “112233”, the original key “hoge”: the original value: “huga”, and the original key “foo”: the original value: “10.5” (see reference symbol 1).

Then, the storage device 11b adds the UID “a058b76a” issued by the UID manager 13 to the entry information (see a reference symbol II).

Then, the storage device 11b transmits, to the KVS cluster 12, a storing instruction to store the key value using the UID as the key and the original key value included in the entry information as the value. In response to the storing instruction, the KVS cluster 12 stores the key value into the KVS 12a (Step A12; see a symbol III in FIG. 18), and the process ends.

The storage device 11b transmits the entry information to the UID manager 13 in parallel with Step A11 or after Step A11. The UID manager 13 adds the information of the UID issued in relation to the entry information to the UID list 13a identified by the present TS (Step A13), and the process ends. In the example of FIG. 18, the UID manager 13 adds the information of the TS “1122”, the original key “hoge”, and the UID “a058b76a”, and the information of the TS “1122”, the original key “foo”, and the UID “a058b76a” to the UID list 13a, respectively (see a symbol IV of FIG. 18).

Further, for example, the storage device 11b refers to the IDX generating flag, and determines whether or not the IDX generating flag is valid, that is, whether or not the IDX generating process is to be performed immediately (Step A14). If the IDX generating flag is invalid (No in Step A14), the process is terminated.

If the IDX generating flag is valid (YES in Step A14), the storage device 11b instructs the IDX manager 15 to execute the IDX generating process. The IDX manager 15 performs the IDX generating processing together with the indexer 16 (Step A15; see symbol V in FIG. 18), and the processing ends.

It should be noted that the process of Steps A12 and A13, and the process of Steps A14 and A15 may be performed in parallel, in other words, asynchronously with each other.

[1-4-3] Entry Retrieving Process:

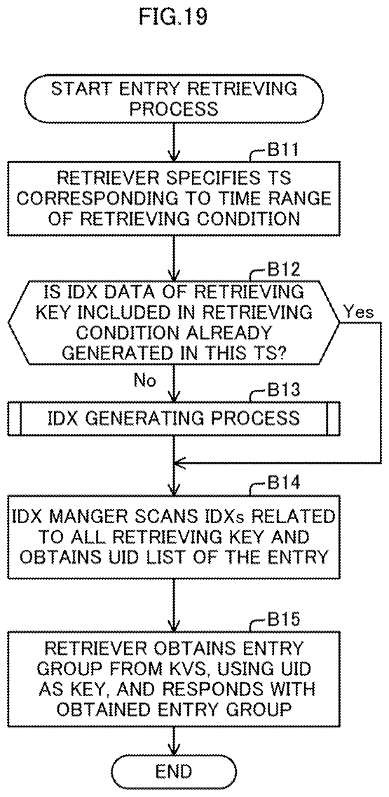

Next, with reference to FIGS. 19 to 21, an example of the operation of the entry retrieving process depicted in Step B2 of FIG. 15 will now be described.

As illustrated in FIG. 19, upon receiving the entry retrieving information from the query receptor 14a, the retriever 14b specifies a TS corresponding to the time range of the retrieving conditions included in the entry retrieving information (Step B11). The retriever 14b transmits a request to obtain the UID list, including the entry retrieving information and the identified TS, to the IDX manager 15.

Next, the IDX manager 15 determines whether the IDX data of the retrieving keys included in the retrieving condition has been generated in the corresponding TS.

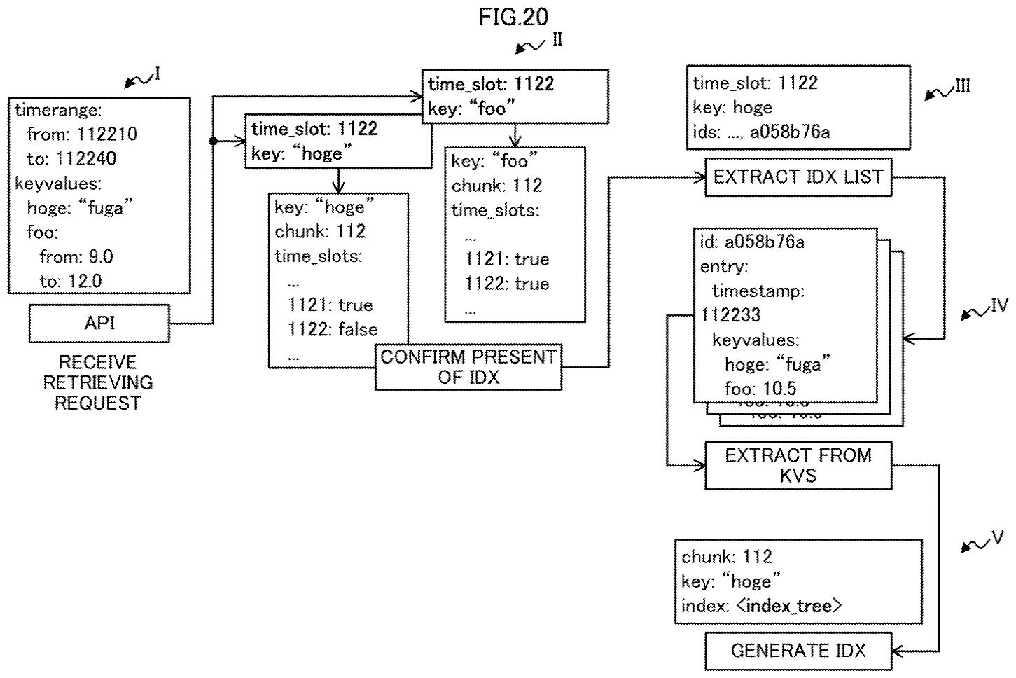

The example of FIG. 20 assumes that the query receptor 14a serving as the retrieval receipt API obtains entry retrieving information of the time range “112210” to “112240”, the retrieving key “hoge”: the retrieving value “fuga”, and the retrieving key “foo”: the retrieving value of “9.0” to “12.0” is obtained (see symbol 1).

In this case, the IDX manager 15 refers to the DX generating status 15a to determine whether or not the IDX data of each of the retrieving keys “hoge” and “foo” in the TS “1122” has been generated (see symbol II).

If the IDX data has already been generated (Yes in Step B12), the process proceeds to Step B14. On the other hand, when the IDX data have not been generated (NO in Step B12), the IDX manager 15 performs the IDX generating process together with the indexer 16 (Step B13), and the process moves to Step B14.

In FIG. 20, the IDX data of the retrieving key “foo” in the TS “1122” has been generated (true) in the DX generating status 15a (Yes in Step B1), as illustrated by the Symbol II. On the other hand, the IDX data of the retrieving key “hoge” in the TS “1122” is not generated (false) (No in Step B12). Therefore, the IDX manager 15 generates the IDX data of the retrieving key “hoge” in the TS “1122” in the IDX generating process of Step B13 (see symbol III to V in FIG. 20 (to be described below)).

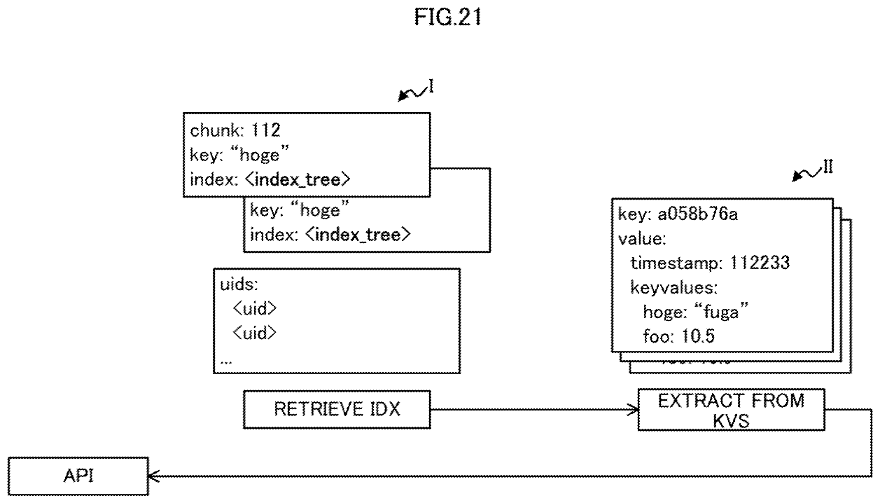

The IDX manager 15 scans (refers to) the IDX 15b for all the retrieving keys included in the retrieving condition, and obtains (extracts) the UIDs to the respective retrieving keys, thereby obtaining (generating) the UID list (Step S14; see symbol 1 of FIG. 21). Then the IDX manager 15 sends the obtained UID list to the retriever 14b.

Upon receiving the UID list from the IDX manager 15, the retriever 14b sends a retrieving request for the value (original key value) including the received UID list to the KVS cluster 12.

The KVS cluster 12 obtains a value (original key value; entry) associated with the key (UID) included in the UID list from the KVS 12a (see symbol II of FIG. 21), and transmits the obtained entry group to the retriever 14b.

The retriever 14b transmits (replies with) the entry group obtained from the KVS cluster 12, to the server 105 as a result of retrieving (Step B15), and the process ends.

[1-4-4] IDX Generating Process:

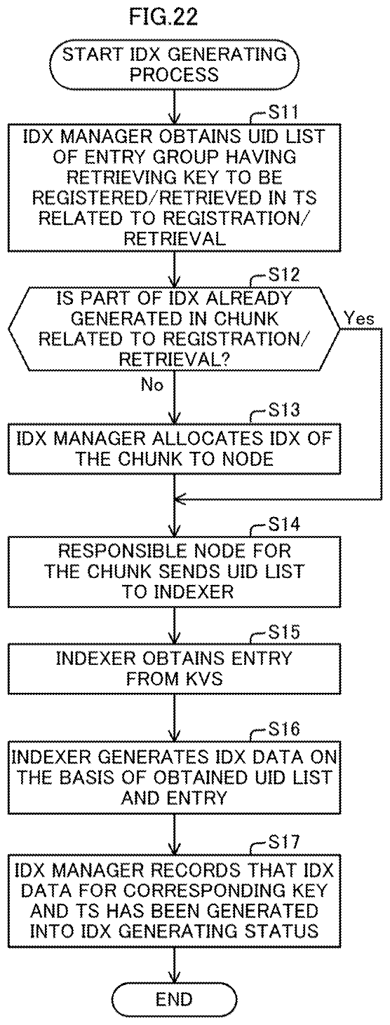

Next, an example of an operation of the IDX generating processing denoted in Step A15 of FIG. 17 and the IDX generating processing denoted in Step B13 of FIG. 19 will be described with reference to FIG. 22 and FIG. 20.

Hereinafter, a TS, a chunk, a retrieving key, and the like related to the IDX generating process illustrated in Step A15 of FIG. 17, which will be referred to as a TS, a chunk, a retrieving key, and the like related to “registration”. In addition, a TS, a chunk, a retrieving key, and the like related to the IDX generating process of Step B13 of FIG. 19 are referred to as a TS, a chunk, a retrieving key, and the like related to “retrieval”.

As illustrated in FIG. 22, the IDX manager 15 transmits a request to obtain a UID list of an entry group having retrieving keys to be registered or retrieved in a TS related to registration or retrieval to the UID manager 13.

Upon receiving the request to obtain the UID list, the UID manager 13 retrieves (extracts) the assigned UID list from the UID list 13a (see symbol III of FIG. 20), and transmits the obtained UID list to the IDX manager 15. The IDX manager 15 obtains the UID list from the UID manager 13 (Step S11).

Upon receipt of the UID list from the UID manager 13, the IDX manager 15 determines whether part of the IDX data in the chunk related to registration or retrieving has already been generated by referring to the IDX generating status 15a (Step S12). For example, in the DX generating status 15a, the IDX manager 15 determines whether or not at least one TS among all the TSs in a chunk or chunks to which the TS to be registration or retrieval belongs is valid.

In cases where at least part of the IDX data has been generated in the chunk (Yes in Step S12), the process moves to Step S14.

On the other hand, in cases where none of the IDX data has been generated in the chunk (No in Step S12), the IDX manager 15 allocates the IDX 15b for the chunk to a node 25 (Step S13), and determines the node 25 as the responsible node. This is for the purpose of leveling the load.

Then, the UID list is transmitted from the node 25 responsible for the chunk to the node 26 of the indexer 16 corresponding to the responsible node 25 in Step S14.

The node 26 of the indexer 16 sends the KVS cluster 12 a request to obtain (retrieve) entries based on the UID-list received from the IDX manager 15. The KVS cluster 12 extracts (retrieves) the entry (value) associated with the UID (key) specified in the UID list from the KVS 12a (see symbol IV in FIG. 20), and transmits the result of the extraction to the indexer 16. The indexer 16 receives the result of the extraction from the KVS cluster 12 (Step S15).

The indexer 16 generates (adds) IDX data to the IDX 15b on the basis of the UID list and the entry group received from the KVS cluster 12, that is, the group of original key values (Step S16; see a symbol V in FIG. 20). Then, the indexer 16 notifies the IDX manager 15 that the generating of the IDX data is completed.

The IDX manager 15 records the completion of the generating the IDX data of retrieving keys and TSs related to the registration or retrieval in the IDX generating status 15a (Step S17), and the process ends.

[1-4-5] Scale-Out Process:

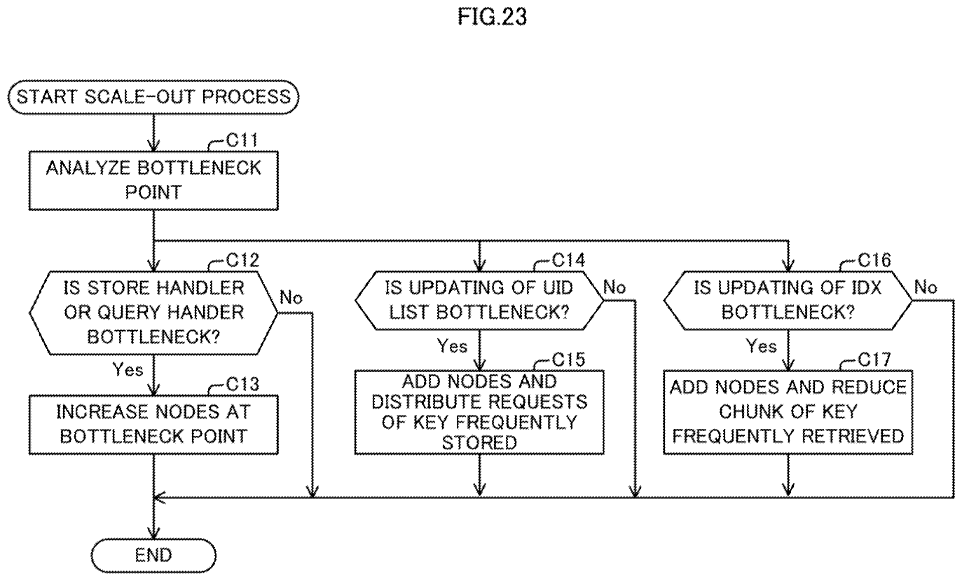

Next, description will now be made in relation to an example of an operation of the process illustrated in Steps C1 and C2 of FIG. 16 with reference to FIG. 23.

As exemplarily illustrated in FIG. 23, the scale-out controller 19 analyzes a bottleneck point on the basis of a result of monitoring the performance of the KVS system 1 (Step C13), and performs the processes of Steps C12, C14, and C16. The processes of steps C12, C14 and C16 may be performed in parallel or in a given order.

The scale-out controller 19 determines whether bottleneck point is the store handler 11 or the query handler 14 (Step C12).

If the bottleneck point is store handler 11 or the query handler 14 (Yes in Step C12), the scale-out controller 19 instructs the store handler 11 or the query handler 14 that is the bottleneck point, to perform a scale-out process.

The store handler 11 or the query handler 14, which is the bottleneck point, increases the number of nodes 21 or 24 at the bottleneck point in response to the instruction to perform the scale-out process (Step C13).

In cases where the scale-out controller 19 issues the instruction at Step C13 or when the bottleneck point is not the store handler 11 or the query handler 14 (No in Step C12), the process is terminated.

The scale-out controller 19 determines whether or not bottleneck point is the UID manager 13 (Step C14).

If the bottleneck point is the UID manager 13 (Yes in Step C14), the scale-out controller 19 instructs the UID manager 13 that is the bottleneck point to perform a scale-out process.

The UID manager 13 of the bottleneck point increases the number of nodes 23 at the bottleneck point in response to the instruction to execute the scale-out process, and distributes the requests for a key frequently stored to multiple nodes 23 (Step 015).

In cases where the UID manager 13 issues the instruction at Step C15, or when the bottleneck point is not the UID manager 13 (No in Step 014), the process is terminated.

In addition, the scale-out controller 19 determines whether or not the bottleneck point is updating (or generating) of the IDX 15b (Step C16).

If the bottleneck point is updating of the IDX 15b or the like (Yes in Step C16), the scale-out controller 19 instructs the IDX manager 15 that is the bottleneck point to execute a scale-out process.

The IDX manager 15 that is bottleneck point increases the number of nodes 25 and/or nodes 26 at the bottleneck point in response to the instruction to perform the scale-out process, and reduces chunks of the key frequently retrieved (Step 017).

In cases where the scale-out controller 19 issues the instruction Step C17, or the bottleneck point is not the updating of the IDX 15b or the like (NO in Step 016), the process ends.

[1-5] Example of Hardware Configuration:

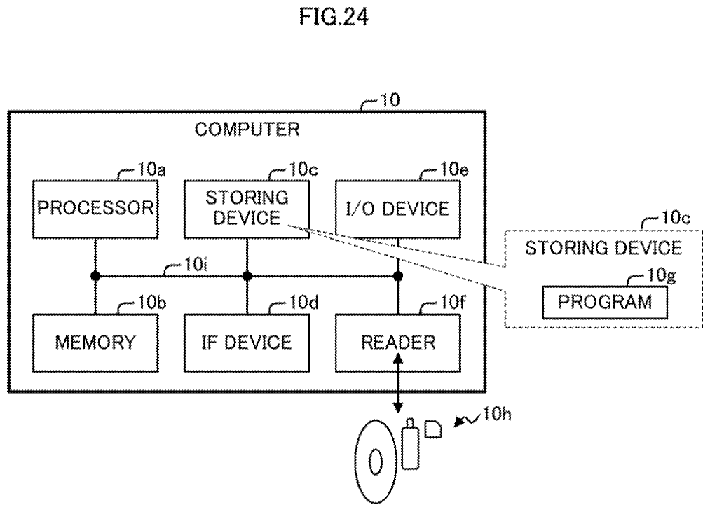

FIG. 24 is a block diagram schematically illustrating an example of the hardware configuration of the computer 10 constituting the HW resource and the NW resource for achieving the multiple nodes included in the KVS system 1 according to one embodiment. The computer 10 may illustratively include a processor 10a, a memory 10b, a storing device 10c, an IF (Interface) device 10d, an I/O (Input/Output) device 10e, and a reader 10f as the HW configuration.

The processor 10a is an example of a processor that performs various controls and calculations. The processor 10a may be communicably connected to the blocks in the computer 10 via a bus 10i. The processor 10a may be a multiprocessor including multiple processors, may be a multicore processor having multiple processor cores, or may have a configuration having multiple multicore processors.

Examples of the processor 10a include an integrated circuit (IC: Integrated Circuit) such as a CPU, a Micro Processing Unit (MPU), a Graphics Processing Unit (GPU), an Accelerated Processing Unit (APU), a Digital Signal Processor (DSP), an Application Specific IC (ASIC), and a Field-Programmable Gate Array (FPGA).

The memory 10b is an example of hardware that stores various types of data, programs, and the like. An example of the memory 10b is a volatile memory such as a Dynamic Random Access Memory (DRAM).

The storing device 10c is an example of hardware that stores various types of data, programs, and the like. Examples of the storing device 10c include a magnetic disk device such as a HDD, a semiconductor drive device such as an SSD, and various storing device such as a nonvolatile memory. Examples of the nonvolatile memory include a flash memory, a Storage Class Memory (SCM), and a Read Only Memory (ROM).

The storing device 10c may store a program 10g that implements all or part of various functions of the computer 10. For example, the processor 10a of the computer 10 can achieve the function as the KVS system 1 depicted in FIGS. 2 and 9 to 13 by expanding the program 10g stored in the storing device 10c into the memory 10b and executing the expanded program 10g.

The IF device 10d is an example of a communication interface that controls connections and communications with a non-illustrated networks (which may include network 103 and 106 of FIG. 1). The IF device 10d may include an adapter compliant with, for example, a Local Area Network (LAN), optical communication (e.g., Fiber Channel (FC)).

The program 10g may be downloaded to the computer 10 from the network via the communication interface and stored in the storing device 10c.

The I/O device 10e may include one or both of an input device, such as a mouse, a keyboard, or an operating button, and an output device, such as a touch panel display, a monitor, such as a Liquid Crystal Display, a projector, or a printer.

The reader 10f is an example of a reader that reads data and programs recorded on the recording medium 10h. The reader 10f may include a connecting terminal or device to which the recording medium 10h can be connected or inserted. Examples of the reader 10f include an adapter conforming to, for example, Universal Serial Bus (USB), a drive apparatus that accesses a recording disk, and a card reader that accesses a flash memory such as an SD card. The program 10g may be stored in the recording medium 10h, and the reader 10f may read the program 10g from the recording medium 10h and store the program 10g into in the storing device 10c.

The recording medium 10h is example of a non-transitory recording medium such as a magnetic/optical disk, and a flash memory. Examples of the magnetic/optical disk include a flexible disk, a Compact Disc (CD), a Digital Versatile Disc (DVD), a Blu-ray Disc™, and a Holographic Versatile Disc (HVD). Examples of the flash memory include a USB memory, and an SD card. Examples of the CD include, for example, a CD-ROM, a CD-R, and a CD-RW. Examples of the DVD include a DVD-ROM, a DVD-RAM, a DVD-R, a DVD-RW, a DVD+R, and a DVD+RW.

The hardware configuration of the computer 10 described above is merely illustrative. Accordingly, the computer 10 may appropriately undergo increase or decrease of hardware (e.g., addition or deletion of arbitrary blocks), division, integration in an arbitrary combination, and addition or deletion of the bus.

In one embodiment, for example, the KVS system 1 in the form of a cloud system may be configured by HW resources and NW resources that are configured by multiple computers 10 that are mutually communicably connected by a non-illustrated networks. In this instance, each of the multiple nodes included in the KVS system 1 may be achieved by logically (virtually) or physically dividing the HW resources and the NW resources configured by the multiple computers 10 and allocating the divided HW resources or the NW resources to the nodes.

In other words, the KVS system 1 may be regarded as a single information processing apparatus including a processor resource (processor), a memory resource (memory), a storage resource (storing device), and an IF resource (IF device) serving as HW resources and NW resources provided by multiple computers 10. The KVS system 1 serving as an information processing apparatus (computer) can allocate the processor resource, the memory resource, the storage resource, and the IF resource to nodes for achieving particular functional blocks, or can cancel allocation of the resources to nodes by the scale-out process.

Each of the multiple functional blocks included in the KVS system 1 may be regarded as a single device (including one or more nodes), and in this case, the KVS system 1 may be regarded as an information processing system including multiple devices.

In addition, in the KVS system 1 serving as a cloud system, a program 10g for achieving a function as the KVS system 1 may be divided into execution units in each of the multiple nodes, and the divided programs may be distributed to and arranged in multiple nodes. As described above, multiple nodes (the multiple nodes 21 to 26) may be any one of multiple physical machines, multiple virtual machines (VM), and a combination of one or more physical machines and one or more virtual machines.

In other words, even if the program 10g is distributedly arranged in multiple nodes, the functions of the KVS system 1 can be regarded as one program that causes the information processing apparatus (computer) or the information processing system to execute the functions of the KVS system 1.

(2) Miscellaneous:

The technique according to the embodiment described above can be implemented by modifying or modifying as follows.

For example, the functional blocks of the KVS system 1 illustrated in FIGS. 2, 9 to 12, and 13 may be merged in any combination, or may be divided. The functional blocks of the KVS-system 1 are the store handler 11, the KVS cluster 12, the UID manager 13, the query handler 14, the IDX manager 15, the indexer 16, the load balancers 17 and 18, and the scale-out controller 19.

In one embodiment, the store handler 11 is assumed to receive a request for storing the key value (original key value) from the IoT device 101, but the embodiment is not limited thereto. Alternatively, the store handler 11 may receive a request to store various forms of data into the KVS cluster 12 from a computer except for the IoT device 101. Accordingly, the value stored in the KVS 12a is not limited to the original key value, and may be various types of schemaless data.

In one aspect, the amount of resources in the process of generating an index for data stored in the key value store can be reduced.

All examples and conditional language provided herein are intended for the pedagogical purposes of aiding the reader in understanding the invention and the concepts contributed by the inventor to further the art, and are not to be construed as limitations to such specifically 0.0 recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory, the processor being configured to execute a procedure comprising:
receiving a storing request to store data into a key value store that stores a key and a value in association with each other;
storing identification information allocated to the data and the data into the key value store;
managing association information that associates identification information allocated to data received in a unit time and contents of the data received in the unit time; and
generating an index of the key value store based on a retrieving request specifying a time point, the association information, and the data stored in the key value store, the retrieving request being a request to retrieve data from the key value store.

2. The information processing apparatus according to claim 1, wherein the procedure further comprises:
extracting, from the association information, identification information associated with the time point specified by the retrieving request;
extracting, from the key value store, data associated with the identification information extracted from the association information; and
generating the index based on the identification information extracted from the association information and the data extracted from the key value store.

3. The information processing apparatus according to claim 1, wherein the procedure further comprises generating the index in a unit of a given time period including a plurality of the successive unit times.

4. The information processing apparatus according to claim 3, wherein the procedure further comprises:
managing generating management information representing whether index data of data received in each unit time included in the given time period is included in the index of the given time period; and
adding, in a case where index data of data received in a unit time corresponding to the time point specified by the retrieving request is not included in the index, the index data to the index.

5. The information processing apparatus according to claim 1, wherein:
data that the storing request requests to store into the key value store includes a key and a value;
the procedure further comprises storing identification information allocated to the data and the data into the key value stored using the identification information and the data including the key and value as a key and a value of the key value store, respectively; and
the association information is information that associates identification information allocated to data received in the unit time with a key of the data received in the unit time.

6. The information processing apparatus according to claim 1, wherein:
the processor is configured to be a processor resources of one or more nodes;
the storing, the key value store, the managing, and the generating are each executed by the one or more nodes;
the procedure further comprises:
monitoring a performance of the information processing apparatus; and
carrying out control that changes at least one of the number of one or more nodes executing the storing, the number of one or more nodes executing the key value store, the number of one or more nodes executing the managing, and the number of one or more nodes executing the generating.

7. The information processing apparatus according to claim 6, wherein the procedure further comprises storing the association information distributedly to the one or more nodes executing the managing for each content of a plurality pieces of the data stored in the key value store by referring to a result of the monitoring.

8. The information processing apparatus according to claim 6, wherein the procedure further comprises storing the index distributedly to the one or more nodes executing the generating for each content of a plurality pieces of the data stored in the key value store by referring to a result of the monitoring.

9. A non-transitory computer-readable recording medium having stored therein an information processing program that causes a computer to execute a process comprising:
receiving a storing request to store data into a key value store that stores a key and a value in association with each other;
storing identification information allocated to the data and the data into the key value store;
managing association information that associates identification information allocated to data received in a unit time and contents of the data received in the unit time; and
generating an index of the key value store based on a retrieving request specifying a time point, the association information, and the data stored in the key value store, the retrieving request being a request to retrieve data from the key value store.

10. The non-transitory computer-readable recording medium according to claim 9, wherein the process further comprises:
extracting, from the association information, identification information associated with the time point specified by the retrieving request;
extracting, from the key value store, data associated with the identification information extracted from the association information; and
generating the index based on the identification information extracted from the association information and the data extracted from the key value store.

11. The non-transitory computer-readable recording medium according to claim 9, wherein the process further comprises generating the index in a unit of a given time period including a plurality of the successive unit times.

12. The non-transitory computer-readable recording medium according to claim 9, wherein the process further comprises:
managing generating management information representing whether index data of data received in each unit time included in the given time period is included in the index of the given time period; and
adding, in a case where index data of data received in a unit time corresponding to the time point specified by the retrieving request is not included in the index, the index data to the index.

13. The non-transitory computer-readable recording medium according to claim 9, wherein:
data that the storing request requests to store into the key value store includes a key and a value;
the process further comprises storing identification information allocated to the data and the data into the key value stored using the identification information and the data including the key and value as a key and a value of the key value store, respectively; and
the association information is information that associates identification information allocated to data received in the unit time with a key of the data received in the unit time.

14. The non-transitory computer-readable recording medium according to claim 9, wherein:
the computer is configured to be a processor resources of one or more nodes;
the storing, the key value store, the managing, and the generating are each executed by the one or more nodes;
the process further comprises:
monitoring a performance of the information processing apparatus; and
carry out control that changes at least one of the number of one or more nodes executing the storing, the number of one or more nodes executing the key value store, the number of one or more nodes executing the managing, and the number of one or more nodes executing the generating.

15. The non-transitory computer-readable recording medium according to claim 9, wherein the process further comprises storing the association information distributedly to the one or more nodes executing the managing for each content of a plurality pieces of the data stored in the key value store by referring to a result of the monitoring.

16. The non-transitory computer-readable recording medium according to claim 9, wherein the process further comprises storing the index distributedly to the one or more nodes executing the generating for each content of a plurality pieces of the data stored in the key value store by referring to a result of the monitoring.

17. An information processing system comprising:
a key value store that stores a key and a value in association with each other;
a storing processor configured to receive a storing request to store data into the key value store, and store identification information allocated to the data and the data into the key value store;
a manager configured to manage association information that associates identification information allocated to data received in a unit time and contents of the data received in the unit time; and
a generator configured to generate an index of the key value store based on a retrieving request specifying a time point, the association information, and the data stored in the key value store, the retrieving request being a request to retrieve data from the key value store.
